(19) United States
(12) Patent Application Publication
(10) Pub. No.: US 2004/0134566 A1
(43) Pub. Date: Jul. 15, 2004

(54) Soft magnetic green compact, manufacturing method for soft magnetic green compact, and soft magnetic powder material

(75) Inventors: Yoshiharu Iyoda, Okazaki-shi (JP); Naoki Kamiya, Chiryu-shi (JP); Ichiro Arita, Okazaki-shi (JP); Kota Maruyama, Toyoake-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: AISIN SEIKI KABUSHIKI KAISHA, Kariya-shi (JP)

(21) Appl. No.: 10/688,890

(22) Filed: Oct. 21, 2003

(30) Foreign Application Priority Data
Oct. 21, 2002 (JP) 2002-305979
Feb. 20, 2003 (JP) 2003-043047

(51) Int. Cl. H01F 1/03

(52) U.S. Cl. 148/105

(57) ABSTRACT

A manufacturing method of a soft magnetic green compact includes mixing a magnetic powder including an iron system powder and a mixed powder including a resin powder, compressively molding the magnetic powder and the mixed powder in a mold by a powder metallurgic method in a mold to form a green compact, and applying thermal treatment to the green compact. The resin powder includes a lubrication function and a binding function. A composition amount of the resin powder assumes 0.10-3.00 weight percent relative to the total weight before the molding and assumes 0.01-0.50 weight percent relative to the total weight after the molding and the thermal treatment

This application is based on and claims priority under 35 U.S.C. § 119 with respect to Japanese Patent Application No. 2003-043047 filed on Feb. 20, 2003 and Japanese Patent Application No. 2002-305979 filed on Oct. 21, 2002, the entire contents of which are incorporated herein by reference.

### FIELD OF THE INVENTION

The present invention relates to a soft magnetic green compact. More particularly, the present invention pertains to a soft magnetic green compact, a manufacturing method for a soft magnetic green compact, and a soft magnetic power material.

### BACKGROUND OF THE INVENTION

It has been known to apply a soft magnetic powder material which includes a powdered soft magnetic material (i.e., principal ingredient is high purity iron powder) and a powdered resin as a material for constructing a magnetic path forming member such as motor core (e.g., a rotor core and a stator core). By applying the pressure and the heat to the soft magnetic powder material, a soft magnetic green compact is formed. The powdered resin includes a binding function to connect iron system powdered particles and an insulating function for electrically insulating between the iron system powdered particles. By electrically insulating between the iron system powdered particles, an electric characteristic (e.g., resistivity) becomes favorable when an alternating-current magnetic field affects the soft magnetic green compact to reduce the eddy current loss of the soft magnetic green compact.

Advantages for forming the soft magnetic powder material with a mold are as follows, which includes a high yield which reduces the manufacturing cost; the high flexibility of the soft magnetic green compact compared to a method for accumulating the steel plate, which reduces the size of the soft magnetic green compact and reduces the manufacturing cost; reducing the processes, which reduces the manufacturing cost; and the high recycling efficiency compared to the method or accumulating the steel plates, which contributes to the environmental conservation and to utilize the resources effectively.

Notwithstanding, there are disadvantages for forming the soft magnetic powder material. First, it is difficult to ensure the strength of the soft magnetic green compact formed with the soft magnetic powder material, particularly, under the high temperature condition because the resin is included in the soft magnetic powder material.

Second, because the resin included in the soft magnetic powder material is adhered to a cavity surface of the mold when applying the heat, it is necessary to devise to easily remove the soft magnetic green compact made of the soft magnetic powder material from the mold.

Third, although the electric characteristic (e.g., resistivity) as the soft magnetic material is improved by the addition of the powdered resin in the soft magnetic powder material, the magnetic characteristic (e.g., the magnetic permeability, the saturation flux density) is declined because the resin is deficient in the magnetic permeability. Thus, it is required to strike a balance between the electric characteristic and the magnetic characteristic at high level.

As explained above, because the high strength under the high temperature condition is not achieved, the known soft magnetic green compact made of the known soft magnetic powder material has not applied to members such as motor core which requires the high strength under the high temperature condition.

The second drawback of forming the soft magnetic green compact made of the soft magnetic powder material may be obviated by lubricating the cavity surface of the mold and by mixing the lubricant in the soft magnetic powder material per se. However, in this case, there are the drawbacks that the manufacturing cost is increased, the productivity is reduce, and the strength of the soft magnetic green compact is reduced by adding and applying the lubricant.

A need thus exists for a soft magnetic powder material, soft magnetic green compact including the soft magnetic powder, and a manufacturing method of the soft magnetic green compact which enables to achieve the high strength under the high temperature condition, to be easily ejected from a mold, and to strike a balance between the magnetic characteristic and the electric characteristic.

### SUMMARY OF THE INVENTION

In light of the foregoing, the present invention provides a manufacturing method of a soft magnetic green compact which includes mixing a magnetic powder formed by coating an insulation film on a surface of an iron system powder and a mixed powder including a resin powder, compressively molding the magnetic powder and the mixed powder by a powder metallurgic method with a mold to form a green compact; and applying thermal treatment to the green compact. The resin powder includes a lubrication function and a binding function. A composition amount of the resin powder assumes 0.10-3.00 weight percent relative to the total weight before the molding and assumes 0.01-0.50 weight percent relative to the total weight after the molding and the thermal treatment.

According to another aspect of the present invention, a manufacturing method of a soft magnetic green compact includes mixing a magnetic powder including an iron system powder and a mixed powder including a resin powder, compressively molding the magnetic powder and the mixed powder in a mold by a powder metallurgic method in a mold to form a green compact, and applying thermal treatment to the green compact. The resin powder includes a lubrication function and a binding function. A composition amount of the resin powder assumes 0.10-3.00 weight percent relative to the total weight before the molding and assumes 0.01-0.50 weight percent relative to the total weight after the molding and the thermal treatment.

According to further aspect of the present invention, a manufacturing method of a soft magnetic green compact includes mixing a magnetic powder including an iron system powder and a mixed powder including a resin powder, compressively molding the magnetic powder and the resin powder in a mold by a powder metallurgic method with a mold to form a green compact, and applying thermal treatment on the green compact. The resin powder includes a lubrication function and a binding function. The resin powder includes a polyamide system resin and a thermoplastic resin having a melting point equal to or higher than 200° C.

According to still another aspect of the present invention, a soft magnetic green compact includes a magnetic powder including an iron system powder provided with an insulation film coating on a surface thereof, a mixed powder including a resin powder, and a green compact formed by compressingly molding the magnetic powder and the resin powder in a mold by a powder metallurgic method, the green compact applied with thermal treatment, and the resin powder including a lubrication function and a binding function. A composition amount of the resin powder assumes 0.10-3.00 weight percent relative to the total weight before the molding and assumes 0.01-0.50 weight percent relative to the total weight after the molding and the thermal treatment.

According to still further aspect of the present invention, a soft magnetic green compact includes a magnetic powder including an iron system powder, a mixed powder including a resin powder, a green compact formed by compressively molding the magnetic powder and the mixed powder by a powder metallurgic method, the green compact applied with thermal treatment, and the resin powder including a lubrication function and a binding function. A composition amount of the resin powder assumes 0.10-3.00 weight percent relative to the total weight before the molding and assumes 0.01-0.50 weight percent after the molding and the thermal treatment.

According to another aspect of the present invention, a soft magnetic green compact includes a magnetic powder including an iron system powder, a mixed powder including a resin powder, a green compact formed by compressively molding the magnetic powder and the mixed powder by a powder metallurgic method, the green compact applied with thermal treatment, and the resin powder including a lubrication function and a binding function. The resin powder includes a polyamide system resin and a thermoplastic resin having a melting point equal to or higher than 200° C.

According to still further aspect of the present invention, a soft magnetic powder material includes a magnetic powder including an iron system powder, a mixed powder including a resin powder, a green compact formed by compressively molding the magnetic powder and the mixed powder by a powder metallurgic method, the green compact applied with thermal treatment, and the resin powder including a lubrication function and a binding function. A composition amount of the resin powder assumes 0.10-3.00 weight percent relative to the total weight before the molding and assumes 0.01-0.50 weight percent relative to the total weight after the molding and the thermal treatment.

### BRIEF DESCRIPTION OF THE DRAWING FIGURES

The foregoing and additional features and characteristics of the present invention will become more apparent from the following detailed description considered with reference to the accompanying drawing figures in which like reference numerals designate like elements.

FIG. 1 illustrates a manufacturing process of a soft magnetic green compact.

FIG. 2 is a graph showing a relationship between a curing ambient (e.g., 300° C.) and a change of a polyamide amount.

FIG. 3 is a chart showing a relationship between a curing temperature, the polyamide amount, and normal temperature strength of a test piece.

FIG. 4 is a chart showing a relationship between the curing temperature, the polyamide amount, and high temperature strength of a test piece.

FIG. 5 is a chart showing a relationship between the curing ambient, the normal temperature strength and the high temperature strength of the test piece.

FIG. 6 illustrates a construction depicting a condition observing an internal construction of the soft magnetic green compact including polyamide system resin and PPS resin with an EPMA.

FIG. 7 is a graph showing a relationship between insulation films and high temperature tension strength of the test piece.

FIG. 8 is a graph showing a relationship between a density of the test piece and effective permeability ratio.

FIG. 9 is a graph showing a relationship between the density of the test piece and the iron loss.

### DETAILED DESCRIPTION OF THE INVENTION

Non-limiting embodiments of the present invention will be explained as follows. A soft magnetic green compact may be formed by hot forming a soft magnetic powder material including iron system powered particles having an insulation film (e.g., insulation film coating) with high electric insulation and polyamide system resin. In this case, the insulation film of the iron system powdered particles may be removed.

A manufacturing method of a soft magnetic powdered material green compact may include a first step for forming a pressurized powder body by applying the pressure on the soft magnetic powdered material mainly including the iron system powdered particles having the insulation film with high electric insulation and polyamide system resin and a second step for heating the pressurized powder body. In this case, the insulation film with high electric insulation may be removed.

The iron system powder particles ensure the magnetic characteristics of the soft magnetic green compact such as permeability, saturation flux density, or the like. For the purpose of ensuring the magnetic characteristics, the average particle diameter of the iron system powder particle may be as large as possible within the range not to deteriorate the compressive forming performance. The average particle diameter of the iron system powder particles may be determined 30-200 μm, 70-500 μm, 70-100 μm, 100-350 μm, or the like. The average particle diameter of the iron system powder particles is not limited to the foregoing. In order to ensure the magnetic characteristics, the iron system powder particles with high purity may be used. For example, it is preferable that 100 percent of the iron system powder includes equal to or greater than 90 weight percent of iron or equal to or greater than 95 weight percent of iron. The iron system powder particle may include Fe-Si system, Fe-Co system, or the like. The iron system powder particles may have a no-sphere configuration with irregular concave or convex portions. In this case, the irregular concave or convex portions hold the resin. The manufacturing method of the iron system powder particles may include atomizing methods such as the water atomizing method and the gas atomizing method, the reduction method (e.g., the gas reduction method), and the mechanical grinding. For example, an inactive gas such as nitrogen and argon gas, and air, or the like, may be used for the gas atomizing method.

Mixing the iron system powder particles and the resin powder including at least one of polyamide system resin or thermoplastic resin having a melting point equal to or greater than 200° C. may form the mixed powder. In this case, if the iron system powder particles have a sphere configuration with high sphericity, the uniformity of the mixture of the resin powder and the iron system powder particles may be deteriorated due to the separation of the resin powder and the iron system powder particles caused by the large specific gravity difference between the resin powder and the iron system powder particles. On the other hand, in case the iron system powder particles have the irregular configuration with the concave or the convex, the resin powder can be held at the iron system powder particles when mixing the resin powder such as the polyamide system resin and the iron system powder particles. This prevents the separation of the resin powder and the iron system powder particles deriving from the specific gravity difference when forming the mixed powder and ensures the uniform diffusion of the mixed powder. Thus, it is preferable that the average particle diameter of the polyamide system resin and the thermoplastic resin powder having the melting point equal to or greater than 200° C. is smaller than the average particle diameter of the iron system powder particles.

The insulation film with high electric insulation may be formed on a surface of the iron system powder particles. The insulation film increases the resistivity of the soft magnetic powder material, reduces the eddy current loop generated in the soft magnetic green compact based on the alternating-current magnetic filed when the alternating-current magnetic field affects the soft magnetic green compact to reduce the eddy current loss. Accordingly, it is preferable to use the insulation film with high electric insulation. The insulation film may cover more than a half of the surface of the iron system powder particles. The insulation film may cover more than two-third of the surface of the iron system powder particles. The insulation film may be covered almost entire surface of the iron powder particles.

The insulation film may include phosphoric acid system film formed by phosphoric conversion treatment. The phosphoric acid system film may include phosphoric acid element, boric acid element, and magnesia element. In this case, the insulation film of the phosphoric acid system may be formed on the surface of the iron system powder particles by a process for contacting the phosphoric acid system treatment liquid including phosphoric acid, boric acid, and magnesia to the surface of the iron system powder particles and a drying process thereafter. Insulation films of phosphoric iron system, insulation films of phosphoric zinc system, and insulation films of phosphoric manganese system, or the like may be used. A thickness of the insulation film may be determined to be 5-5000 nm, 5-1000 nm, 5-500 nm, or the like, for the purpose of ensuring the resistivity and the magnetic permeability. The thickness of the insulation film is not limited to the above-mentioned range. In case the thickness of the insulation film is too thick, the magnetic characteristics such as the magnetic permeability may be declined although the eddy current loss is prevented because the resistivity is ensured. The thickness of the insulation film is determined considering the above-mentioned conditions. The foregoing insulation film may be removed or reduced depending on the required strength and the usage. In case the insulation film is removed or reduced, the iron system powder particles are connected, which improves the high temperature strength of the soft magnetic green compact.

The polyamide (PA) system resin including amido group in a molecule construction is a thermoplastic resin with a relatively low melting point and the high lubrication. The polyamide system resin includes PA6, PA66, PA11, PA12, PA46, or the like, and a copolymer including at least two of PA6, PA66, PA11, PA12, PA46. The polyamide system resin having the melting point of 100-200° C., 120-190° C., 130-180° C., or the like may be used.

The polyamide system resin used for the soft magnetic powder material may be in the powdered form. Too large average particle diameter of the resin powder is disadvantageous to ensure the high temperature strength and to strike a balance between the magnetic characteristics such as the magnetic permeability and the saturation magnetic flux density and the electric characteristics such as resistivity. It is preferable that the particle diameter of the polyamide system resin is smaller than the particle diameter of the iron system powder particles.

The resin functions as the lubricant for improving the molding performance, the mold removability (i.e., degree of the ejection force applied when removing the green compact from the mold), and the normal temperature strength. However, because the melting point of the resin is lower than the melting point of the iron system powder, the high temperature strength including larger amount of the resin is declined when the soft magnetic green compact is used. Thus, by reducing the resin by the thermal treatment, the high temperature strength of the soft magnetic green compact is ensured. According to the embodiment of the present invention, the composition amount of the resin powder may assume 0.10-3.00 weight percent relative to the total weight before the forming and the composition amount of the resin powder may assume 0.01-0.50 weight percent relative to the total weight after the forming and the thermal treatment. The composition amount of the resin powder may be 0.01-0.45 weight percent, 0.01-0.40 weight percent, or the like after the forming and the thermal treatment relative to the total weight after than forming and the thermal treatment.

According to the embodiment of the present invention, as the total resin amount in the soft magnetic powder material before the forming increases, the ratio of the iron system powder particle is relatively declined. As the magnetic characteristics of the soft magnetic green compact such as the magnetic permeability and the saturation magnetic flux density is declined, the high temperature strength is declined. As the total resin amount is reduced, the magnetic characteristics are improved because the relative ratio of the iron system powder particle is increased. However, as the total resin amount is reduced, a binding function for bonding the iron system powder particles and the polyamide system resin is relatively reduced, which declines the lubrication relative to the mold.

Considering the foregoing conditions and the soft magnetic powder material (i.e., including the iron system powder particles and the resin) before the forming is determined to be 100 percent, the ratio of the polyamide system resin may be equal to or less than 3.00 weight percent, may be equal to or less than 1 weight percent, may be equal to or less than 0.8 weight percent, may be equal to or less than 0.7 weight percent, or the like. In case the soft magnetic powder material including the iron system powder particle and the resin before the forming, the total resin amount may be determined 0.10-3.00 weight percent, may be 0.1-2.0 weight percent, 0.1-1.0 weight percent, or the like.

The soft magnetic green compact is formed by applying the pressure and by heating the soft magnetic powder material. The application of the pressure and the heating may be performed individually or may be performed simultaneously. In this case, the soft magnetic green compact is formed by the first process for forming the pressurized powder body by compressively forming the soft magnetic powder material in the mold such as a mold and the second process for curing by heating the pressurized powder body thereafter. The first process can be preformed in the normal temperature. By applying the pressure to the soft magnetic powder material at the normal temperature, the adhesion of the resin to a cavity surface of the mold is restricted. Thus, the pressurized powder body can be favorably molded from the cavity surface.

The applied pressure at the first process is varied depending on the variation of the iron system powder particles and the configuration of the soft magnetic green compact. The applied pressure at the first process may be 50 MPa-1000 MPa (i.e., approximately 500 kgf/cm²-approximately 1000 kgf/cm² when 1 kgf/cm² is approximately equal to 0.1 MPa). The applied pressure at the first process may be 100 MPa-800 MPa (i.e., approximately 1000 kgf/cm²-approximately 8000 kgf/cm²). Provided that the soft magnetic powder material is heated simultaneous with the application of the pressure thereto, the resin included in the soft magnetic powder material may be adhered to the cavity surface of the mold such as a metal mold, which makes it difficult to remove the green compact from the mold and the productivity is declined. Thus, the first process is performed at the normal temperature or at the approximately normal temperature. The pressurizing time at the first process may be 0.1-20 seconds, 0.5-10 seconds, 0.5-5 seconds, or the like. Shorter pressurizing time is preferable for improving the productivity. The atmosphere may be used for the ambient of the first process. The inactive gas ambient may be used for the first process.

At the second process, it is preferable to increase the adhesiveness relative to the iron system powder particle by melting the polyamide system resin. Thus, the second process is performed while heating the pressurized powder body. Because the melting point of the polyamide system resin (PA) is relatively low, the polyamide system resin is likely to flow at the grain boundary between the iron system powder particles. Thus, by providing the polyamide system resin flowing on the surface of the iron system powder particles as a piece or a membrane, the polyamide system resin is more likely to effectively function as the insulation film like the phosphoric acid system film than when the polyamide system resin is provided as the particles. This is advantageous to increase the resistivity of the soft magnetic powder material and the soft magnetic green compact to restrain the eddy current loss. However, if the polyamide system resin excessively flows at the grain boundary between the iron system powder particles, the magnetic characteristics of the soft magnetic green compact may declined and the adhesion strength between the iron system powder particles may be declined. Thus, for the purpose of ensuring the magnetic characteristics and the strength of the soft magnetic green compact, the excessive fluidity of the polyamide system resin is not preferable.

Too high heating temperature at the thermal treatment may deteriorate the resin included in the soft magnetic powder material and may excessively create the oxide film at the surface of the iron system powder particles. The insulation film may be deteriorated when the insulation film is provided. On the other hand, the adhesive force by the resin included in the soft magnetic powder material is limited and is not improved when the heating temperature at the thermal treatment is too low. The heating temperature may be determined equal to or less than 450° C., more preferably, equal to or less than 350° C., or the like. Accordingly, the heating temperature at the second process may be determined equal to or less than 450° C., more preferably, equal to or less than 350° C., or the like. The lower limit temperature at the second process may exceed the melting point of the polyamide system resin. The lower limit temperature at the second process may be equal to or higher than 100° C., equal to or higher than 200° C., or the like in order to accelerate the decomposition by the heat and the oxygen and to accelerate the binding by the evaporation and by the oxidization between iron powders. Thus, the heating temperature for heating the soft magnetic powder material may be 250-450° C., 200-350° C., or the like. Further, the increasing temperature at heating the soft magnetic powder material may be 0.1-2° C. per second. With the foregoing sintering at the low temperature, the excessive grow of the oxide film at the surface of the iron system powder particles is restrained even at the atmosphere.

The atmosphere corresponding to the oxidizing ambient may be used at the second process. The inactive gas ambient may be used at the second process. Because the second process is not performed in the mold such as the metal mold but is performed at the unbound state, it is not necessary to consider the mold removability (i.e., degree of the ejection force applied when removing the green compact from the mold) relative to the mold such as the metal mold. The curing may be performed by heating the soft magnetic powder material simultaneous with applying the pressure to the soft magnetic powder material for the pressurized powder molding.

According to the embodiment of the present invention, the resin may include the polyamide system resin and the thermoplastic resin having the melting point equal to or higher than 200° C. The thermoplastic resin having the melting point equal to or higher than 200° C. (refereed as a second thermoplastic resin hereafter) includes the thermoplastic resin having the melting point equal to or greater than 250° C., the thermoplastic resin having the melting point equal to or greater than 260° C., the thermoplastic resin having the melting point equal to or greater than 270° C., or the like. The second thermoplastic resin may include the resin having higher melting point than the polyamide system resin. The second thermoplastic resin may include polyphenylene sulfide (PPS) system resin. Polyphenylene sulfide is the thermoplastic material having high melting point and excellent crystalline to perform the favorable heat resistance and the electric insulation even under the high temperature environment. Polyphenylene sulfide may be a straight chain type. Polyphenylene sulfide may be bridged type. Polyphenylene sulfide system resin includes other elements than polyphenylene sulfide.

The composition amount of the polyamide system resin and the thermoplastic resin having the melting point equal to or greater than 200° C. may be 0.10-3.00 weight percent relative to the total weight before the forming. The composition amount of the polyamide system resin and the thermoplastic resin having the melting point equal to or greater than 200° C. may be 0.01-0.80 weight percent relative to the total weight after the forming and the thermal treatment. In this case, the composition amount of the polyamide system resin and the thermoplastic resin having the melting point equal to or greater than 200° C. may be 0.01-0.70 weight percent, 0.01-0.60 weight percent, or the like after the forming and the thermal treatment. Because the thermoplastic resin having the melting point of equal to or higher than 200° C. is unlikely evaporate, the relative resin amount after the forming and the thermal treatment is increased relative to the polyamide system resin.

In order to ensure the adhesion strength of the iron system powder resin, it is preferable to directly bond the insulation films of the irons system powder particles or between the irons system powder particles than providing the resin therebetween. However, in this case, the removability from the mold is not sufficient because the resin is not included to deteriorate the green compact when removing the green compact from the mold and decline the productivity. When the melting point of the second thermoplastic resin is higher than the melting point of the polyamide system resin, the second thermoplastic resin blocks the excessive fluidity of the polyamide system resin within the boarder region of the iron system powder particles at the heating or at the usage because the second thermoplastic resin is unlikely melting than the polyamide system resin. Thus, the excessive covering of the insulation film of the iron system powder particles by the polyamide system resin may be restrained.

The polyamide system resin and the second thermoplastic resin before the forming of the soft magnetic powder material may be the powdered form. With the polyamide system resin and the second thermoplastic resin, if the average particle diameter of the resin powder is too large, it is disadvantageous to ensure the high temperature strength and to strike a balance between the magnetic characteristics such as magnetic permeability and the saturation magnetic flux density and the electric characteristics such as the resistivity of the soft magnetic system green compact at high level. Thus, it is preferable that the particle diameter of the polyamide system resin and the second thermoplastic resin is smaller than the diameter of the iron system powder particles. The particle diameter of the polyamide system resin and the second thermoplastic resin may be equal to or less than 200 μm, may be equal to or less than 100 μm, may be equal to or less than 50 μm, may be equal to or less than 10 μm, or the like. The polyamide system resin and the second thermoplastic resin with the diameter equal to or less than 200 μm, equal to or less than 100 μm, equal to or less than 50 μm, may be equal to or greater than 80 weight percent of each resin. When the average particle diameter of the polyamide system resin is determined to be D1 and the average particle diameter of the second thermoplastic resin is determined to be D2, D1 may be equal to D2, D1 may be approximately equal to D2, D1 may be smaller than D2, and D1 may be larger than D2. In this case, the average particle diameter of the iron system powder particle is larger than the average particle diameter of the resin powder.

When the sum of the polyamide system resin and the thermoplastic resin having the melting point equal to or greater than 200° C. is determined to be a resin total amount, the resin total amount may be 0.1-3.0 weight percent out of 100 percent of the soft magnetic system powder material before the forming. In this case, the rest of the weight percent out of 100 percent substantially corresponds to the iron system powder. When the sum of the polyamide system resin and the thermoplastic resin having the melting point equal to or higher than 200° C. is determined as a total resin amount (100%), the ratio of the polyamide system resin may be 1-99 weight percent, may be 20-80 weight percent, or the like. When the sum of the polyamide system resin and the thermoplastic resin having the melting point equal to or higher than 200° C. is determined as a total resin amount (100%), the ratio of the thermoplastic resin having the melting point equal to or greater than 200° C. may be 1-99 weight percent, 20-80 weight percent, or the like. When the amount of the second thermoplastic resin in the total resin amount is excessively small, the high temperature strength is unlikely improved depending on the usage of the soft magnetic green compact. Although the second thermoplastic resin is advantageous to ensure the high temperature strength, by increasing the amount of the second thermoplastic resin the ratio of the polyamide system resin is relatively decreased, thus the lubrication performance may be declined to decline the removability of the green compact from the mold.

The density of the soft magnetic green compact may be 6.6-7.4 g/cm³. The low density does not ensure the strength of the soft magnetic green compact. When the density is excessive, the mold is likely to be damaged and the high temperature strength of the soft magnetic green compact is declined.

The soft magnetic green compact is used for a magnetic path forming member applied to an electromagnetic actuator such as a motor and an electromagnetic valve. The magnetic path forming memb r applied to the motor includes a rotor core, a stator core, or the like. The motor includes an anti-lock brake system motor, a power steering motor, a wiper motor, a wind regulator motor, sunroof motor, or the like. The soft magnetic green compact may be used for the magnetic path forming member applied to a sensor such as a torque sensor and a displacement sensor. The soft magnetic green compact formed with the soft magnetic powder material is suitable for the soft magnetic green compact used at the high temperature environment such as engine room of a vehicle. However, because the soft magnetic green compact formed with the soft magnetic powder material of the embodiments of the present invention is effective for favorable mold removability from the cavity of the mold, the usage of the soft magnetic green compact is not limited to the high temperature environment usage.

A first embodiment of the present invention will be explained as follows. A metal powder and the polyamide system resin are used as initial materials.

Somaloy 550 of Hoganos is used as the metal powder. The metal powder is formed by piling an ultra thin phosphoric acid system film on a surface of high purity iron system powder particles (e.g., iron powder, Fe equal to or less than 0.01 weight percent, H₂loss 0.08 weight percent, particle diameter approximately 20-200 μm) as magnetic powder by the phosphoric acid forming film treatment. The phosphoric acid system film functioning as the insulation film with high electric insulation is laminated on the approximately entire surface of the iron system powder particles. The iron system powder particles are approximately pure iron, which ensures excellent soft magnetic characteristics. The high electric insulation resistance of the phosphoric acid film is advantageous to reduce the eddy current loss of the soft magnetic green compact when the alternating magnetic filed affects.

Polyamide system resin (e.g., PA66, average particle diameter approximately 10 μm) is used as the other of the initial materials. The maximum particle diameter of the polyamide system resin is equal to or less than 200 μm. The average particle diameter corresponds to most frequent value of the particle size distribution. The polyamide system resin is the thermoplastic resin with favorable lubrication and functions as the powder lubricant. The polyamide system resin contributes to ensure the adhesion strength with the iron system powder particles at the normal temperature region. The melting point of the polyamide system resin used in this embodiment of the present invention is approximately 140° C.

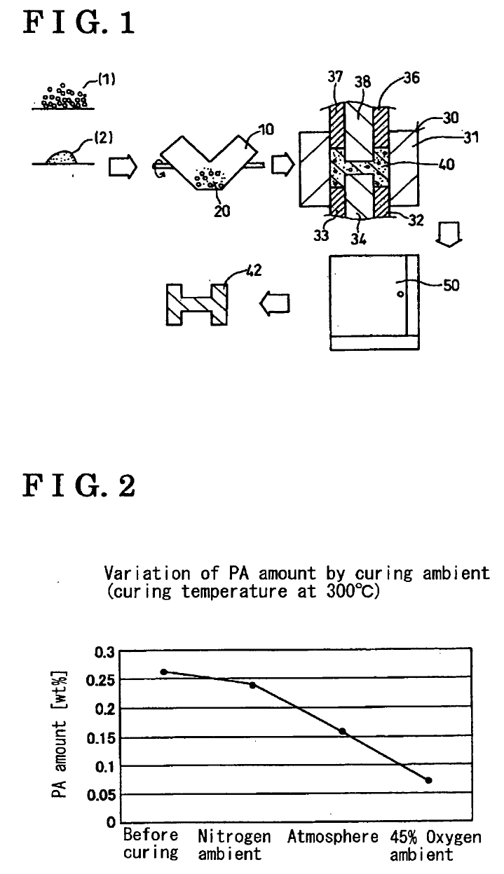

As shown in FIG. 1, mixing a predetermined amount of the iron system powder and a predetermined amount of powdered resin by rotating a mixer 10 for 60 minutes forms the mixed powder 20. A first process is performed using the soft magnetic powder material corresponding to the mixed powder 20 including the iron system powder particles and the polyamide system resin. More particularly, the soft magnetic powder material is supplied to a cavity of a mold 30 and pressurized to be formed in the mold at the room temperature to obtain a green compact 40 corresponding to the pressurized powder body. The mold 30 includes a cylindrical dies type 31, a bottom type 32 fitted into the die type 31, and a top type 36 fitted into the die type 31. The bottom type 32 includes a cylindrical external bottom type 33 and an internal bottom type 34. The top type 36 includes a cylindrical external top type 37 and an internal top type 38.

With the embodiment of the present invention, although the pressures is applied to the mixed powder 20 corresponding to the soft magnetic powder material in the cavity of the mold 30, the resin of the mixed powder does not melt because the pressure is applied at the room temperature. Thus, the solid lubrication function of the resin is ensured and is advantageous to resolve the drawback of adhesion of the resin on the cavity type surface of the mold 30. The condition for applying the pressure on the mixed powder 20 corresponding to the soft magnetic material is determined as 600 Mpa (approximately 6000 kgf/cm²) of the pressure power and approximately one second of pressuring time.

Thereafter, as a second process, the curing (thermal treatment) of the green compact 40 is performed by heating the green compact 40 corresponding to the pressurized powder body removed from the cavity of the mold 30 in a heat-treating furnace 50 at the atmosphere (i.e., oxygen-bearing ambient, oxidizing ambient) to obtain a soft magnetic green compact 42. The second process is a low temperature sintering at the atmosphere, which is the oxidizing ambient. At the second process, the heating temperature is 300° C. and the heating time is 60 minutes. At the second process, the pressure is not applied and the green compact 40 is at unbinding state. Accordingly, it is maximally prevented to adhere the green compact 40 and the soft magnetic green compact 42 to the mating parts.

The second process is performed at the atmosphere. In other words, the heating treatment is performed at the ambient including approximately 20 volume percent oxygen to connect the iron system powder particles. Further, decomposing and evaporating the polyamide system resin by the heat and the oxygen can relatively increase the ratio of the bonding dimension between the iron system powder particles. Thus, the high temperature strength is increased and the stable strength can be ensured under the high temperature environment.

By the second process, the polyamide system resin included in the green compact 40 is decomposed and evaporated by the heat and the oxygen. Accordingly, as shown in FIG. 2, the resin composition amount included in the green compact treated with the heating treatment is reduced relative to the resin composition amount (PA amount) composed as the soft magnetic powder material in advance. Particularly, the resin is likely to reduce when the oxygen-bearing ambient such as the atmosphere ambient and the ambient including the 45% of the oxygen (volume percent) corresponds to the curing ambient.

The composition amount of the resin powder is determined to be 0.10-3.00 weight percent relative to the total weight before the forming. The composition amount of the resin powder is determined to be 0.01-050 weight percent relative to the total weight after the forming and the thermal treatment.

Further, a test piece is produced determining the resin remained in the soft magnetic green compact 42 after the curing at 0.3 weight percent, 0.4 weight percent, and 0.6 weight percent relative to the total weight (i.e., iron system powder and the resin) of the soft magnetic green compact 42 after the forming and the thermal treatment. In this case, the resin composition amount relative to the total weight of the soft magnetic powder material before the curing is determined approximately 0.15 weight percent when it is 0.3 weight percent after the curing, is approximately 0.25 weight percent when it is 0.4 weight percent after the curing, and is approximately 0.45 weight percent when it is 0.6 weight percent after the curing. The resin remained in the soft magnetic green compact 42 after the curing is measured by the combustion analysis (i.e., CS analysis, JIS G1211).

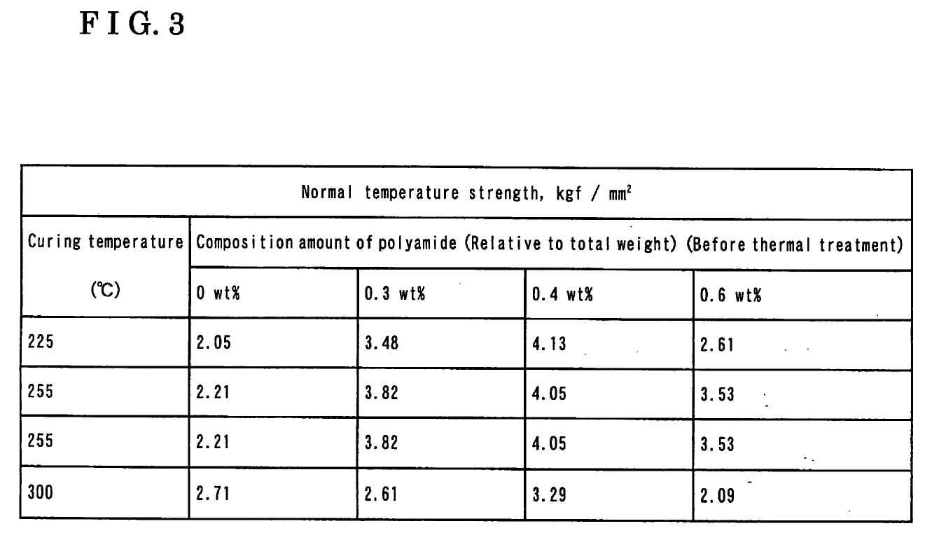

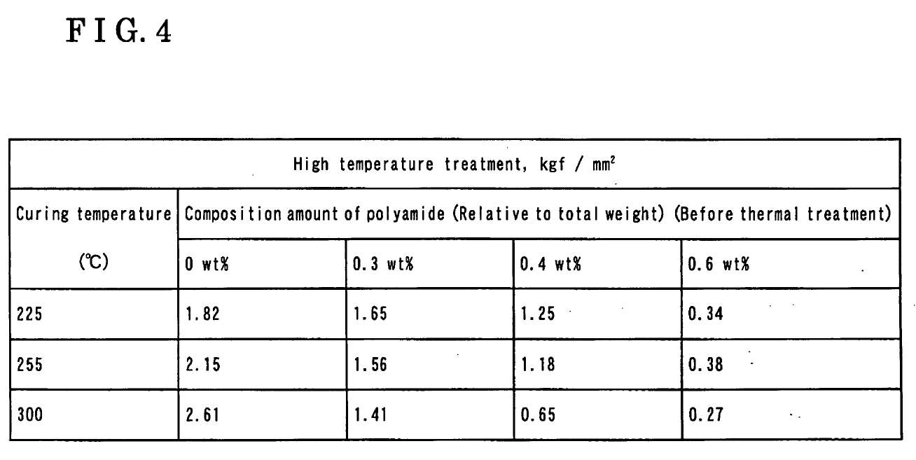

Further, a comparison example including the resin remained in the soft magnetic green compact 42 after the curing at zero weight percent relative to the total weight of the soft magnetic green compact is provided. The tension strength experiment is performed for each test piece to measure the normal temperature strength and the high temperature strength. The tension strength experiment is performed based on Metal Material Experiment Method of JIS Z-2241. A chart as shown in FIG. 3 shows a relationship between the curing temperature, the resin composition amount (PA) of the soft magnetic green compact after the curing, and the tension strength (kgf/mm²) at the normal temperature. A chart as shown in FIG. 4 shows a relationship between the curing temperature, the resin composition amount (PA) of the soft magnetic green compact after the curing, and the tension strength (kgf/mm²) at the high temperature (200° C.). As shown in FIG. 3, as the resin composition amount (PA) increases, the normal temperature of the soft magnetic green compact after the curing is increased. However, the strength is declined if the resin composition amount (PA) is excessive. As shown in FIG. 4, the less the resin composition amount (PA), the higher the high temperature. This derives from the melting of the resin.

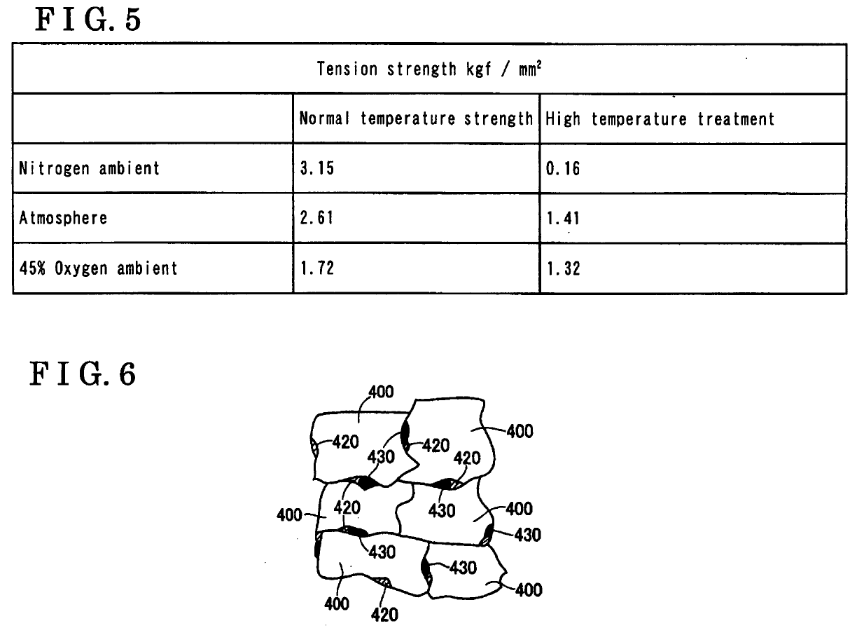

The normal temperature strength and the high temperature strength (200° C.) depending on the curing ambient (nitrogen ambient, atmosphere ambient, oxygen 45 volume percent ambient) concerning the test piece including 0.3 weight percent of the resin composition amount (PA) including the lubrication function and the binding function is measured. The measurement result is shown in FIG. 5. As shown in a chart of FIG. 5, the high temperature strength of the soft magnetic green compact after the curing excels when the curing is performed at the ambient including the oxygen (atmosphere ambient, oxygen 45 volume ambient) than performing the curing at the ambient without the oxygen.

A second embodiment is likewise the first embodiment. The second embodiment will be explained showing the different feature from the first embodiment. Acceding to the first embodiment of the present invention, the metal powder (iron powder, Fe equal to or less than 0.01 weight percent, particle diameter approximately 20-200 μm) formed by piling the phosphoric acid system film on the surface of the iron system powder particles with high purity is used. With the second embodiment of the present invention, high purity iron system powder particles (iron powder, Fe equal to or less than 0.01 weight percent, particle diameter approximately 20-200 μm) without lamination of the phosphoric acid system film are used.

Likewise the first embodiment of the present invention, the soft magnetic green compact 42 is obtained by the second process by performing the curing of the green compact 40 by heating (300°, for one hour) the green compact 40 corresponding to the pressurized powder body removed from the cavity of the mold 30 at the atmosphere (oxygen-bearing ambient) by the heat-treating furnace 50. The second process is the low temperature sintering. Although the iron system powder particle is sintered at the atmosphere, because the iron system powder particle is sintered at the low temperature, the excessive grow of the oxide film at the surface of the iron system powder particles is restrained and the diffusion of the oxygen in the particles at the oxide film is expected to ensure the sintering performance.

The resin powder (polyamide system resin, PA66, average particle diameter approximately 10 μm) includes the lubrication function and the binding function. The resin powder does not include PPS. Likewise the first embodiment, the composition amount of the resin powder before forming is 0.10-3.00 weight percent relative to the total weight before the forming. The composition amount of the resin powder after the forming and the thermal treatment is 0.01-0.50 weight percent relative to the total weight after the forming. The less the composition amount of the resin powder, the higher the high temperature of the soft magnetic green compact after the curing.

A third embodiment of the present invention will be explained as follows. The high purity iron system powder particles without the lamination of the phosphoric acid system film (i.e., iron powder, Fe equal to or less than 0.01 weight percent, particle diameter approximately 20-200 μm) is used as the metal powder. The resin powder includes the polyamide system resin (PA66, average particle diameter approximately 10 μm) and the PPS resin (average particle diameter 18 μm, melting point approximately at 280° C.). The average particle diameter of the PPS resin is larger than the average particle diameter of the polyamide system resin. The average particle diameter corresponds to the most frequent value of the particle size distribution.

The polyamide system resin is the thermoplastic resin with favorable lubrication functioning as the powdered lubricant for increasing the powder filling performance and the mold removability. The polyamide system resin contributes to ensure the adhesion strength with the iron system powder particles at the normal temperature region. The melting point of the polyamide system resin used in the third embodiment of the present invention is approximately at 140° C. The PPS resin functions as the second thermoplastic resin for increasing the adhesion strength with the iron system powder particles, particularly, for increasing the adhesion strength under the high temperature environment.

Likewise the first embodiment, a predetermined amount of the iron powder, a predetermined amount of the polyamide system resin, a predetermined amount of the PPS resin are mixed for 60 minutes in the mixer 10 by rotating the mixer 10 to form the mixed powder 20. Then, the green compact 40 corresponding to the pressurized powder body 40 is obtained likewise the first embodiment. Thereafter, the second process (the low temperature sintering at the atmosphere) is performed by curing the green compact 40 by heating the green compact 40 corresponding to the pressurized powder body removed from the cavity of the mold 30 in the heat-treating furnace 50 at the atmosphere (oxygen-bearing ambient) to obtain the soft magnetic green compact 42. At the second process, the binding function to bond the iron system powder particles is increased by heating the polyamide system resin and the PPS resin to melt. The heating condition at the second process is determined to have the heating temperature of 300° C. (equal to or greater than the melting point of the PPS resin) and the heating time for 60 minutes. The pressure is not applied at the second process and the green compact 40 is unbound. This prevents the green compact 40 and the soft magnetic green compact 42 adhered to the mating parts at the second process.

A test piece shown in FIG. 6 includes approximately 0.3 weight percent polyamide system resin and 0.3 weight percent PPS resin before the forming by weight ratio. The test piece includes approximately 0.14 weight percent of the polyamide system resin and approximately 0.29 weight percent of the PPS resin by the weight ratio after the forming.

As shown in FIG. 6, flake phases 420 (shown with hatched lines) of the polyamide system resin and flake phases 430 (shown with black color) of the PPS resin are at the boarder region of iron system powder particles 400. As shown in FIG. 6, the flake phases 420 of the polyamide system resin and the flake phases 430 are not melted each other and are rather independent from each other. As shown in FIG. 6, the flake phases 420 of the polyamide system resin and the flake phases 430 positioned at concave portions of the iron system powder particles 400. Further as shown in FIG. 6, the excessive fluidity of the flake phase 420 of the polyamide system resin is blocked by the flake phase 430 of the PPS resin. In order to block the excessive fluidity of the flake phase 420 of the polyamide system resin, it is effective that the particle diameter of the PPS resin is larger than the particle diameter of the polyamide system resin.

According to the experiment, the adhesion strength between the iron system powder particles is high because the strength after the curing is high although the mold removability from the mold 30 is undesirable. With the flake phase 430 of the PPS resin restraining the excessive fluidity of the flake phase 420 of the polyamide system resin, the iron system powder particles 400 may be connected to contribute to ensure the strength of the soft magnetic green compact 42.

The likeability to remove the green compact 40 from the cavity of the mold 30 (the degree of the pressure at removing) has to be concerned in the embodiments. In this case, the pressure at removing of the green compact 40 is required to be small. Generally, the lubricant may be applied to the cavity surface of the mold 30, the soft magnetic powder metal and the lubricant may be mixed, or the like to reduce the degree of the pressure at removing. However, this means have drawbacks of increasing the manufacturing cost and declining the productivity. In addition, the performance and the strength of the soft magnetic green compact 42 after the curing may be declined. To the contrary, by mixing the predetermined amount of the polyamide system resin having the lubrication function in addition to the biding function in the soft magnetic powder material, the pressure at removing when removing the green compact 40 from the cavity of the mold 30 can be reduced.

However, in case only the polyamide system resin is mixed, the strength of the soft magnetic green compact may be significantly declined when used at the high temperature environment (e.g., 180-260° C.) such as a motor positioned at the engine room. It is assumed because the environment temperature exceeds the melting point of the polyamide system resin. The PPS resin, for example, is used in order to resolve the problem. The melting point of the PPS resin is considered approximately 270-290° C., which is higher than the aforementioned high temperature environment. Thus, because the PPS resin does not melt at the foregoing high temperature environment, the adhesive force of the PPS resin is exhibited as the adhesion strength when using the soft magnetic green compact 42 at the high temperature environment. In addition, the PPS resin functions as a barrier for preventing the excessive fluidity of the melted polyamide system resin at the high temperature environment from contacting the surface of the iron system powder particles 400, which further improves the strength at the high temperature environment.

With the embodiments of the present invention, the resin powder (polyamide system resin and PPS resin) includes the lubrication function and the binding function. Likewise the first embodiment of the present invention, the composition amount of the resin powder (polyamide system resin and PPS resin) is 0.10-3.00 weight percent relative to the total weight before the forming and is 0.01-0.50 weight percent relative to the total weight after the forming and the thermal treatment.

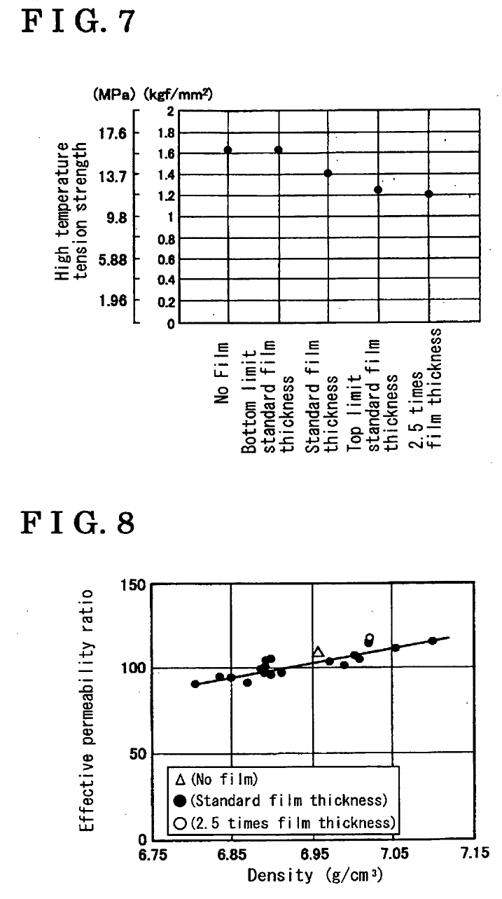

The influence of the insulation film (phosphoric acid system) covering the surface of the iron powder particles on the high temperature tension strength (200° C.) was experimented. FIG. 7 shows the test result. As shown in FIG. 7, the test piece with “no film” corresponds to the test piece applied with the iron powder particles without insulation film. The test piece with “standard film thickness” corresponds to the test piece applied with the iron powder covered with the insulation film with standard thickness. The test piece with “bottom limit standard film thickness” corresponds to the test piece applied with the iron powder covered with the insulation film having a thickness determined to be the bottom limit of the standard thickness. The test piece with “top limit standard film thickness” corresponds to the test piece applied with the iron powder covered with the insulation film having a thickness determined to be the top limit of the standard thickness. The test piece with “2.5 times film thickness” corresponds to the test piece applied with the iron powder particles covered with the insulation film having a thickness determined to be 2.5 times of the standard thickness. As shown in FIG. 7, the high temperature tension strength of the soft magnetic green compact is increased even if the insulation film is not provided.

FIG. 8 shows the measurement result of the relationship between the density and the effective permeability ratio. The effective permeability ratio is measured under a state energizing the alternating electric current of 400 Hz to a toroidal coil to generate the alternating magnetic filed (1.3T). As shown in FIG. 8, the effective permeability ratio is high and favorable with the test piece with 2.5 times film thickness. The effective permeability ratio is high and favorable with the test piece without insulation film.

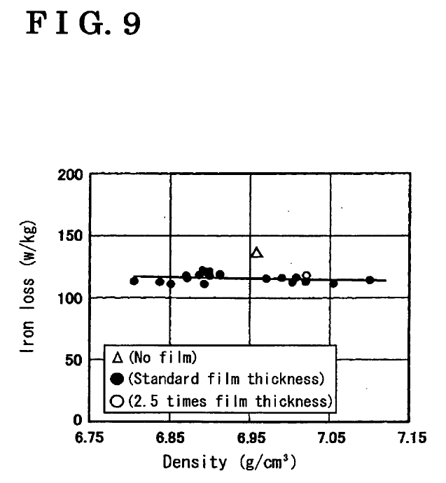

FIG. 9 shows the measurement result of the relationship between the density and the iron loss of the soft magnetic green compact corresponding to the test piece. In this case, the relationship between the density and the iron loss of the soft magnetic green compact is measured under the state energizing the alternating electric current of 400 Hz to the toroidal coil to generate the alternating magnetic field (1.3T). Generally, less iron loss is preferable. As shown in FIG. 9, the iron loss is reduced with the test piece of standard film thickness and the test piece of the 2.5 times film thickness. On the other hand, although the iron loss of the test piece with no film is slightly higher than the test piece with standard film thickness and the test piece with 2.5 times film thickness, practically, no problem. Accordingly, with the test piece of no film, considering that the high temperature tension strength of the soft magnetic green compact is favorable, the shatter-resistance is favorable, and manufacturing cost is reduced because there is no insulation film, thus the favorable evaluation is obtained.

The test pieces obtained the data shown in FIGS. 7-9. The test pieces correspond to the soft magnetic green compact including 0.3 weight percent of the polyamide system resin and the 0.3 weight percent of the PPS resin and are formed based on the third embodiment of the present invention. The polyamide system resin is reduced after the thermal treatment to be 0.15 weight percent, the PPS is reduced to be 0.3 weight percent, and the resin ratio after the thermal treatment assumes 0.45 weight percent.

With the soft magnetic green compact including 0.4 weight percent of polyamide system resin and 0.4 weight percent of the PPS resin after the forming includes 0.25 weight percent of the polyamide system resin and the 0.4 weight percent of the PPS resin after the thermal treatment. The resin ratio after the thermal treatment assumes 0.65 weight percent.

With the soft magnetic green compact including 0.5 weight percent of the polyamide system resin and 0.4 weight percent of the PPS resin after the forming, the polyamide system resin is reduced to be 0.35 weight percent and the PPS resin assumes 0.4 weight after the thermal treatment. The resin ratio after the thermal treatment assumes 0.75 weight percent.

According to the embodiment of the present invention, the soft magnetic green compact is suitable for using at the high temperature environment such as in the engine room.

According to the embodiment of the present invention, the manufacturing method of the soft magnetic green compact includes a mixing process for forming the soft magnetic powder material including the iron system powder particles and the polyamide system resin, a pressuring process (first step) for forming the pressurized powder body by applying the pressure to the soft magnetic powder material with mold, and a low temperature sintering process (second step) for heating the pressurized powder body at the oxidizing ambient such as the atmosphere ambient at the temperature of 100-450° C.

According to the embodiment of the present invention, the manufacturing method of the soft magnetic green compact includes a mixing process for forming the soft magnetic powder material including the iron system powder particles, the polyamide system resin, and the th rmoplastic resin having the melting point equal to or higher than 200° C., the pressuring process (first step) for forming the pressurized powder body by applying the pressure on the soft magnetic powder material in the mold, and a low temperature sintering step (second step) for heating the pressurized powder body under the oxidizing ambient such as at the atmosphere ambient at the temperature of 100-450° C.

According to the embodiment of the present invention, the average particle diameter of the iron system powder particle is larger than the average particles diameter for the polyamide system resin.

According to the embodiment of the present invention, the soft magnetic green compact includes the iron system powder particles, the polyamide system resin, and the thermoplastic resin having the melting point equal to or higher than 200° C. The average particle diameter of the thermoplastic resin having the melting point equal to or higher than 200° C. is larger than the average particle diameter of the polyamide system resin. The average particle diameter of the iron system powder particles is larger than the average particle diameter of the thermoplastic resin having the melting point equal to or higher than 200° C.

According to the embodiment of the present invention, with the soft magnetic green compact material for applying the thermal treatment to the green compact after compressively molding the magnetic powder including the iron system powder and the mixed powder including the resin powder by the powder metallurgic method to form the green compact, the resin powder includes the polyamide system resin and the thermoplastic resin having the melting point equal to or higher than 200° C., the composition amount of the resin powder assumes 0.10-3.00 weight percent before the forming and 0.01-0.80 weigh percent relative to the total weight after the forming and the thermal treatment.

According to the embodiment of the present invention, the soft magnetic green compact with high mold removability from the mold cavity of the mold, with the improvement of the strength at the high temperature environment, and with striking a balance between the magnetic characteristics such as the magnetic permeability and the saturation magnetic flux density and the electric characteristics such as the resistivity at high level can be achieved.

According to the embodiments of the present invention, the total weight before the forming corresponds to the total weight of the magnetic powder portion and the resin portion before the forming. When the composition amount of the resin powder (resin portion) is 0.10 percent relative to the total weight, the remained portion (99.90 percent) is substantially the magnetic powder portion.

According to the embodiments of the present invention, the resin functioning as the lubricant at the forming contributes to improve the molding performance, mold removability, and the normal temperature strength. However, because the melting point of the resin is lower than the iron system powder, the high temperature strength of the soft magnetic green compact is declined when the amount of the resin is larger. Thus, the amount of the resin is reduced by the thermal treatment. This ensures the high temperature strength of the soft magnetic green compact.

The insulation film coating covering the surface of the iron system powder increases the resistivity of the soft magnetic powder material and reduces the eddy current loop generated in the soft magnetic green compact to reduce the eddy current loss.

According to the embodiments of the present invention, the thermoplastic resin having the melting point equal to or higher than 200° C. mainly includes polyphenylene sulfide system resin. The thermoplastic resin having the melting point equal to or higher than 200° C. ensures the high temperature strength of the soft magnetic green compact.

The principles, preferred embodiment and mode of operation of the present invention have been described in the foregoing specification. However, the invention which is intended to be protected is not to be construed as limited to the particular embodiments disclosed. Further, the embodiment described herein is to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A manufacturing method of a soft magnetic green compact comprising:
mixing a magnetic powder including an iron system powder and a mixed powder including a resin powder;
compressively molding the magnetic powder and the mixed powder in a mold by a powder metallurgic method in a mold to form a green compact; and
applying thermal treatment to the green compact; wherein
the resin powder includes a lubrication function and a binding function; and wherein
a composition amount of the resin powder assumes 0.10-3.00 weight percent relative to the total weight before the molding and assumes 0.01-0.50 weight percent relative to the total weight after the molding and the thermal treatment.

2. A manufacturing method of a soft magnetic green compact comprising:
mixing a magnetic powder formed by coating an insulation film on a surface of an iron system powder and a mixed powder including a resin powder;
compressively molding the magnetic powder and the mixed powder by a powder metallurgic method with a mold to form a green compact; and
applying thermal treatment to the green compact; wherein
the resin powder includes a lubrication function and a binding function; and wherein
a composition amount of the resin powder assumes 0.10-3.00 weight percent relative to the total weight before the molding and assumes 0.01-0.50 weight percent relative to the total weight after the molding and the thermal treatment.

3. The manufacturing method of the soft magnetic green compact according to claim 1, wherein the resin powder includes a polyamide system resin whose maximum particle diameter is equal to or smaller than 200 μm.

4. A manufacturing method of a soft magnetic green compact comprising:
mixing a magnetic powder including an iron system powder and a mixed powder including a resin powder;
compressively molding the magnetic powder and the resin powder in a mold by a powder metallurgic method with a mold to form a green compact; and
applying thermal treatment on the green compact; wherein
the resin powder includes a lubrication function and a binding function; and wherein
the resin powder includes a polyamide system resin and a thermoplastic resin having a melting point equal to or higher than 200° C.

5. The manufacturing method of the soft magnetic green compact according to claim 4, wherein a composition amount of the polyamide system resin and the thermoplastic resin having the melting point equal to or higher than 200° C. assumes 0.10-3.00 weight percent relative to a total weight before the molding and assumes 0.01-0.80 weight percent relative to a total weight after the molding and the thermal treatment.

6. The manufacturing method of the soft magnetic green compact according to claim 4, wherein the thermoplastic resin having the melting point equal to or higher than 200° C. includes polyphenylene sulfide system resin.

7. The manufacturing method of the soft magnetic green compact according to claim 1, wherein the thermal treatment is performed at 100-450° C.

8. The manufacturing method of the soft magnetic green compact according to claim 1, wherein the green compact after the thermal treatment includes density of 6.6-7.4 g/cm³.

9. The manufacturing method of the soft magnetic green compact according to claim 1, wherein the thermal treatment is performed at oxidizing ambient.

10. A soft magnetic green compact comprising: ‘a magnetic powder including an iron system powder;
a mixed powder including a resin powder;
a green compact formed by compressively molding the magnetic powder and the mixed powder by a powder metallurgic method, the green compact applied with thermal treatment; and
the resin powder including a lubrication function and a binding function; wherein
a composition amount of the resin powder assumes 0.10-3.00 weight percent relative to the total weight before the molding and assumes 0.01-050 weight percent after the molding and the thermal treatment.

11. A soft magnetic green compact comprising:
a magnetic powder including an iron system powder provided with an insulation film coating on a surface thereof;
a mixed powder including a resin powder;
a green compact formed by compressingly molding the magnetic powder and the resin powder in a mold by a powder metallurgic method, the green compact applied with thermal treatment; and
the resin powder including a lubrication function and a binding function; wherein
a composition amount of the resin powder assumes 0.10-3.00 weight percent relative to the total weight before the molding and assumes 0.01-0.50 weight percent relative to the total weight after the molding and the thermal treatment.

12. The soft magnetic green compact according to claim 10, wherein the resin powder includes a polyamide system resin whose maximum particle diameter is equal to or smaller than 200 μm.

13. A soft magnetic green compact comprising:
a magnetic powder including an iron system powder;
a mixed powder including a resin powder;
a green compact formed by compressively molding the magnetic powder and the mixed powder by a powder metallurgic method, the green compact applied with thermal treatment; and
the resin powder including a lubrication function and a binding function; wherein
the resin powder includes a polyamide system resin and a thermoplastic resin having a melting point equal to or higher than 200° C.

14. The soft magnetic green compact according to claim 13, wherein the thermoplastic resin having the melting point equal to or higher than 200° C. includes a polyphenylene sulfide system resin.

15. The soft magnetic green compact according to claim 10, wherein the thermal treatment is performed at 100-450° C.

16. The manufacturing method of the soft magnetic green compact according to claim 10, wherein the green compact after the thermal treatment includes density of 6.6-7.4 g/cm³.

17. A soft magnetic powder material comprising:
a magnetic powder including an iron system powder;
a mixed powder including a resin powder;
a green compact formed by compressively molding the magnetic powder and the mixed powder by a powder metallurgic method, the green compact applied with thermal treatment; and
the resin powder including a lubrication function and a binding function; wherein
a composition amount of the resin powder assumes 0.10-3.00 weight percent relative to the total weight before the molding and assumes 0.01-0.50 weight percent relative to the total weight after the molding and the thermal treatment.
